(19) United States
(12) Patent Application Publication
(10) Pub. No.: US 2024/0306527 A1
(43) Pub. Date: Sep. 19, 2024

(54) FLUID GROUND-ENGAGING TOOL ACTUATION SYSTEM

(71) Applicant: CNH Industrial America LLC, New Holland, PA (US)

(72) Inventors: Christopher Schoeny, Minooka, IL (US); Trevor Philip Stanhope, Oak Lawn, IL (US); Grant Thomas MacDonald, Hampshire, IL (US)

(21) Appl. No.: 18/120,590

(22) Filed: Mar. 13, 2023

(51) Int. Cl. A01B 63/114; A01B 63/00; A01B 63/10

(52) U.S. Cl. CPC A01B 63/114; A01B 63/008; A01B 63/1006

(57) ABSTRACT

A control system for an agricultural implement includes an electric pump fluidly coupled to a fluid cylinder and configured to control a fluid pressure within the fluid cylinder. The fluid cylinder is configured to apply a force to a ground-engaging tool of the agricultural implement. The electric pump is disposed on the agricultural implement.

### BACKGROUND

The present disclosure relates generally to a fluid ground-engaging tool actuation system.

Generally, planting implements (e.g., planters) are towed behind a tractor or other work vehicle via a mounting bracket secured to a rigid frame of the implement. Planting implements typically include multiple row units distributed across a width of the implement. Each row unit is configured to deposit seeds at a desired depth beneath the soil surface of a field, thereby establishing rows of planted seeds. For example, each row unit typically includes an opener that forms a seeding path (e.g., trench) for seed deposition into the soil. An agricultural product conveying system (e.g., seed tube or powered agricultural product conveyor) is configured to deposit seeds and/or other agricultural products (e.g., fertilizer) into the trench. The opener/agricultural product conveying system is followed by closing disc(s) that move displaced soil back into the trench and/or packer wheel(s) that pack the soil on top of the deposited seeds/other agricultural products. Certain row units may also include residue management wheel(s) positioned in front of the opener and configured to break up and/or displace residue and debris (e.g., clods) on the soil surface.

Certain planting implements include a control system configured to control a force applied by the closing disc(s) to the soil and/or a force applied by the packer wheel to the soil during operation of the planting implement, thereby establishing a desired soil profile behind the planted seeds/other agricultural products. Additionally or alternatively, the control system may control a force applied by the residue management wheel(s) to enable the residue management wheel(s) to effectively break up/displace the residue/debris. For example, the force applied by at least one ground-engaging tool (e.g., the closing disc(s), the packer wheel(s), the residue management wheel(s), or a combination thereof) to the soil may be controlled by respective cylinder(s) (e.g., hydraulic cylinder(s), pneumatic cylinder(s), or a combination thereof) in an actuation system, and the control system may control pressure (e.g., fluid pressure, air pressure) within the respective cylinder(s). Actuator(s) may be used to control pressure(s) in the respective cylinder(s), and pressure sensor(s) may be used to monitor the pressure in the actuation system. With regard to hydraulic cylinder(s), the work vehicle (e.g., tractor) is generally used to provide hydraulic fluid for the hydraulic cylinder(s). For example, a pump on the work vehicle may be used to provide the hydraulic fluid from a hydraulic fluid supply on the work vehicle to the hydraulic cylinder(s), and both the pump and the hydraulic fluid supply may be sized for the maximum possible number of hydraulic cylinders regardless of how many hydraulic cylinder(s) are installed on a particular agricultural implement. In addition, hydraulic hoses may be used to transport the hydraulic fluid from the hydraulic fluid supply to the hydraulic cylinder(s), which may cause power loss during the transport of the hydraulic fluid.

With regard to pneumatic cylinder(s), the work vehicle (e.g., tractor) is generally used to provide air (e.g., from an air tank) for the pneumatic cylinder(s). For example, a pump on the work vehicle may be used to provide the air from an air tank on the work vehicle to the pneumatic cylinder(s), and both the pump and the air tank may be sized for the maximum possible number of pneumatic cylinders regardless of how many pneumatic cylinder(s) are installed on a particular agricultural implement. In addition, long air-lines are generally used in systems implementing pneumatic cylinder(s), which may result in slow response and/or power loss during the transport of the air.

### SUMMARY OF THE INVENTION

In certain embodiments, a control system for an agricultural implement includes an electric pump coupled to a fluid cylinder, and the electric pump is disposed on the agricultural implement. The control system includes a controller communicatively coupled to the electric pump. The controller includes a memory and a processor. The controller is configured to determine a target fluid pressure inside the fluid cylinder based on a target force of the fluid cylinder to apply to a ground-engaging tool of the agricultural implement. The controller is configured to control the electric pump to adjust a fluid pressure inside the fluid cylinder such that a difference between the fluid pressure and the target fluid pressure is less than a threshold.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural implement having multiple row units distributed across a width of the agricultural implement;

FIG. 2 is a side view of an embodiment of a row unit that may be employed on the agricultural implement of FIG. 1; and

FIG. 3 is a schematic diagram of an embodiment of an actuation system that may be employed within the agricultural implement of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

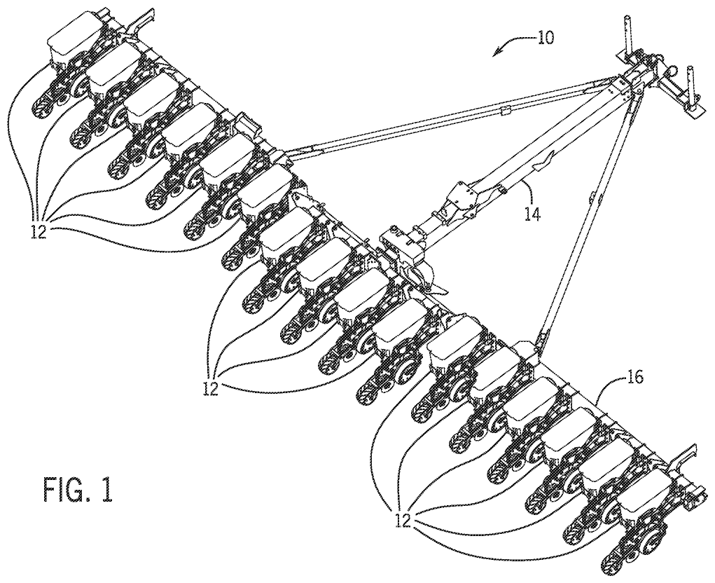

FIG. 1 is a perspective view of an embodiment of an agricultural implement 10 (e.g., planting implement, planter) having multiple row units 12 (e.g., planter row units) distributed across a width of the agricultural implement 10. The agricultural implement 10 is configured to be towed through an agricultural field behind a work vehicle, such as a tractor. As illustrated, the agricultural implement 10 includes a tongue assembly 14, which includes a hitch configured to couple the agricultural implement 10 to an appropriate tractor hitch (e.g., via a ball, clevis, or other coupling). The tongue assembly 14 is coupled to a tool bar 16 which supports multiple row units 12. Each row unit 12 may include one or more opener discs configured to form a seed path (e.g., trench) within soil of the field. The row unit 12 may also include an agricultural product conveying system (e.g., seed tube or powered agricultural product conveyer) configured to deposit seeds and/or other agricultural product(s) (e.g., fertilizer) into the seed path/trench. In addition, the row unit 12 may include closing disc(s) and/or packer wheel(s) positioned behind the agricultural product conveying system. The closing disc(s) are configured to move displaced soil back into the seed path/trench, and the packer wheel(s) are configured to pack soil on top of the deposited seeds/other agricultural product(s). Additionally or alternatively, the row unit 12 may include residue management wheel(s) positioned in front of the opener discs and configured to break up and/or displace residue and debris (e.g., clods) on a surface of the soil.

In certain embodiments, the agricultural implement 10 includes a fluid actuation system. The fluid actuation system includes a control system to control the fluid cylinder(s) (e.g., hydraulic cylinder(s), pneumatic cylinder(s)) in the fluid actuation system. The control system includes an electrical pump to provide fluid for a fluid cylinder from a fluid supply in the system. The fluid cylinder is configured to apply a force (e.g., an up-force and a downforce) via an actuator to a ground-engaging tool of the agricultural implement 10, such as the closing disc(s), the packer wheel(s), or the residue management wheel(s) of a respective row unit 12. The control system includes a valve assembly configured to control a fluid pressure inside the fluid cylinder thereby controlling the force applied by the fluid cylinder to the ground-engaging tool. The electrical pump may be dedicated for the fluid cylinder, or used for each controlled ground-engaging tool (e.g., one electrical pump for the closing disc control cylinders, one electrical pump for the press wheel control cylinders, etc.), or used for each row unit 12 of the agricultural implement 10, the size of the electrical pump may be determined only based on the corresponding fluid cylinder(s). Accordingly, the total pump capacity may be based on number of fluid cylinders associated with the electrical pump, which reduces energy consumption (e.g., smaller size electrical pumps may be used). The electrical pump and the valve assembly are disposed on the agricultural implement 10, in certain embodiments, on the row unit 12 (e.g., coupled to the frame of the row unit). The electrical pump and the valve assembly are communicatively coupled to the control system and electrically powered, e.g., by an electrical supply on the work vehicle. In addition, in certain embodiments, the fluid actuation system may be closed-circuit, in which the fluid flows in-between the electrical pump and the respective fluid cylinder(s), through connecting hoses, without going back into an external tank (e.g., a tank on the work vehicle) shared with other electrical pumps. Accordingly, the fluid supply of the closed-circuit fluid actuation system does not rely on an external fluid supply (e.g., from the work vehicle). Therefore, power loss and slow response due to transport of the fluid (e.g., transport the fluid from the work vehicle to the row unit 12) may be reduced, and response time and shock loads may be improved. In some embodiments, may be on the agricultural implement 10, and in certain embodiments the fluid supply may be on the work vehicle. Since the fluid supply is dedicated for each electrical pump in the closed-circuit fluid actuation system, the system may provide stable power and loads

For example, for a closed-circuit electro-hydraulic cylinder(s), the hydraulic fluid supply is on the agricultural implement. Accordingly, the length of hydraulic hoses used to transport the hydraulic fluid from the hydraulic fluid supply to the electro-hydraulic cylinder(s) is substantially reduced compared to the system with the hydraulic fluid supply on the work vehicle, thereby reduces power loss during the transport of the hydraulic fluid and increases the response speed due to less transport time used to transport the hydraulic fluid. Since the electrical pump is dedicated for the respective electro-hydraulic cylinder(s), or used for each controlled ground-engaging tool (e.g., one electrical pump for the closing disc control cylinders, one electrical pump for the press wheel control cylinders, etc.), or used for each row unit 12 of the agricultural implement 10, the total pump capacity may be based on number of electro-hydraulic cylinders associated with the electrical pump, which reduces energy consumption (e.g., smaller size electrical pumps may be used). In addition, the amount of hydraulic fluid in the hydraulic supply is determined based on the respective electro-hydraulic cylinder(s), accordingly, the hydraulic fluid resource may be used efficiently and the electro-hydraulic cylinder(s) may provide stable power and loads.

In another example, for a closed-circuit electro-pneumatic cylinder(s), the air reservoir may be on the agricultural implement. Accordingly, the length of air hoses used to transport the air from the air reservoir to the electro-pneumatic cylinder(s) is substantially reduced, thereby reduces power loss during the transport of the air and increases the response speed due to less transport time used to transport the air. Since the electrical pump is dedicated for the respective electro-pneumatic cylinder(s), or used for each controlled ground-engaging tool (e.g., one electrical pump for the closing disc control cylinders, one electrical pump for the press wheel control cylinders, etc.), or used for each row unit 12 of the agricultural implement 10, the total pump capacity may be based on number of electro-pneumatic cylinders associated with the electrical pump, which reduces energy consumption (e.g., smaller size electrical pumps may be used). In addition, the amount of air in the air reservoir is determined based on the respective electro-hydraulic cylinder(s), accordingly, the air resource may be used efficiently and the electro-pneumatic cylinder(s) may provide stable power and loads.

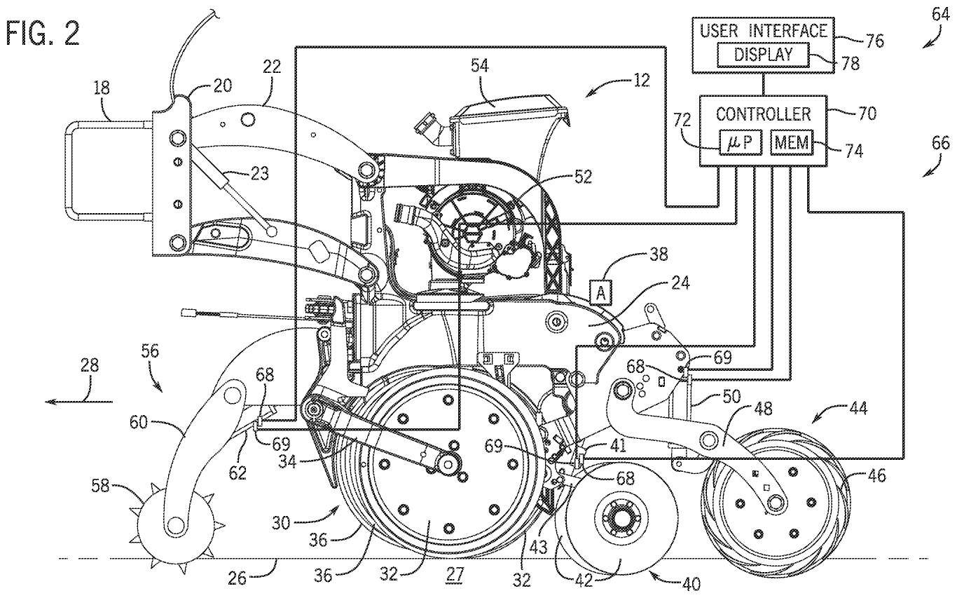

FIG. 2 is a side view of an embodiment of a row unit 12 (e.g., agricultural row unit) that may be employed on the agricultural implement of FIG. 1. The row unit 12 includes a mount 18 configured to secure the row unit 12 to the tool bar of the agricultural implement. In the illustrated embodiment, the mount 18 includes a u-bolt that secures a bracket 20 of the row unit 12 to the tool bar. However, in other embodiments, the mount may include another suitable device that couples the row unit to the tool bar. A linkage assembly 22 extends from the bracket 20 to a frame 24 of the row unit 12. The linkage assembly 22 is configured to enable vertical movement of the frame 24 relative to the tool bar in response to variations in a surface 26 of the soil 27. In certain embodiments, a down pressure system 23 (e.g., including a hydraulic actuator, a pneumatic actuator, etc.) may be coupled to the linkage assembly 22 and configured to urge the frame 24 toward the soil surface 26. While the illustrated linkage assembly 22 is a parallel linkage assembly (e.g., a four-bar linkage assembly), in other embodiments, another suitable linkage assembly may extend between the bracket and the frame.

The row unit 12 is configured to deposit seeds and/or other agricultural product(s) at a target depth beneath the soil surface 26 as the row unit 12 traverses a field along a direction of travel 28. The row unit 12 includes an opener assembly 30 that forms a trench in the soil 27 for seed/other agricultural product deposition into the soil. In the illustrated embodiment, the opener assembly 30 includes gauge wheels 32, arms 34 that pivotally couple the gauge wheels 32 to the frame 24, and opener discs 36. The opener discs 36 are configured to excavate a trench into the soil 27, and the gauge wheels 32 are configured to control a penetration depth of the opener discs 36 into the soil. In the illustrated embodiment, the row unit 12 includes a depth control actuator 38 configured to control the vertical position of the gauge wheels 32 (e.g., by blocking rotation of the arms in the upward direction beyond a selected orientation), thereby controlling the penetration depth of the opener discs 36 into the soil. The depth control actuator 38 may include any suitable type(s) of actuator(s) (e.g., hydraulic actuator(s), pneumatic actuator(s), electromechanical actuator(s), manual lever, manual knob, etc.), and the depth control actuator 38 may control the vertical position of the gauge wheels 32 via any suitable mechanical linkage (e.g., a linkage configured to block rotation of the arms 34 in the upward direction beyond a selected orientation that is controlled by the depth control actuator 38). While the illustrated opener assembly 30 includes two gauge wheels 32 and two opener discs 36 in the illustrated embodiment, in other embodiments, the opener assembly may include more or fewer gauge wheels (e.g., 0, 1, 3, or more) and/or more or fewer opener discs (e.g., 0, 1, 3, or more). For example, in certain embodiments, the gauge wheels may be omitted, and other suitable device(s) (e.g., skid(s), ski(s), etc.) may be used to control the penetration depth of the opener disc(s) into the soil. Furthermore, in certain embodiments, the opener discs may be omitted, and other suitable opener(s) (e.g., shank(s), knife/knives, etc.) may be used to form the trench within the soil.

The row unit 12 also includes an agricultural product conveying system (e.g., seed tube or powered agricultural product conveyor) configured to deposit seeds and/or other agricultural product(s) (e.g., fertilizer) into the trench. The opener assembly 30 and the agricultural product conveying system are followed by a closing assembly 40 that moves displaced soil back into the trench. In the illustrated embodiment, the closing assembly 40 includes two closing discs 42. However, in other embodiments, the closing assembly may include other suitable closing device(s) (e.g., a single closing disc, etc.). In the illustrated embodiment, the closing assembly 40 includes a fluid cylinder 41 extending between the frame 24 of the row unit 12 and an arm 43 of the closing assembly 40. As illustrated, the arm 43 is pivotally coupled to the frame 24, and the fluid cylinder 41 is configured to control a force applied by the closing disc(s) 42 to the soil 27. Furthermore, while the fluid cylinder 41 extends to the arm 43 of the closing assembly 40 in the illustrated embodiment, in other embodiments, the fluid cylinder may extend to any suitable portion of the closing assembly (e.g., in embodiments in which the arm is omitted), such as to a hub of the closing disc(s). In addition, in certain embodiments, the closing assembly, including the closing disc(s), the arm, and the fluid cylinder, may be omitted.

In the illustrated embodiment, the closing assembly 40 is followed by a packing assembly 44 configured to pack soil on top of the deposited seeds and/or other agricultural product(s). The packing assembly 44 includes a packer wheel 46, an arm 48 that pivotally couples the packer wheel 46 to the frame 24, and a fluid cylinder 50 configured to control a force applied by the packer wheel 46 to the soil surface 26, thereby enabling the packer wheel to pack soil on top of the deposited seeds and/or other agricultural product(s). As illustrated, the fluid cylinder 50 extends between the frame 24 of the row unit 12 and the arm 48 of the packing assembly 44. However, in other embodiments, the fluid cylinder may extend to any other suitable portion of the packer assembly, such as to a hub of the packer wheel. While the packing assembly 44 includes a single packer wheel 46 in the illustrated embodiment, in other embodiments, the packing assembly may include one or more additional packer wheels (e.g., arranged in a tandem configuration). Furthermore, in certain embodiments, the packing assembly, including the packer wheel, the arm, and the fluid cylinder, may be omitted.

The row unit 12 includes a vacuum seed meter 52 configured to receive agricultural product (e.g., seeds) from a hopper 54. In certain embodiments, the vacuum seed meter 52 includes a disc having multiple openings. An air pressure differential between opposite sides of the disc induces the agricultural product (e.g., seeds) to be captured within the openings. As the disc rotates, the agricultural product is conveyed toward the agricultural product conveying system. When the agricultural product (e.g., seed) is aligned with an inlet to the agricultural product conveying system, the pressure on each side of the disc is substantially equalized (e.g., at the end of a vacuum passage), thereby enabling the agricultural product (e.g., seed) to enter the agricultural product conveying system (e.g., seed tube or powered agricultural product conveyor). The agricultural product conveying system then directs the agricultural product to the trench. While the illustrated embodiment includes a vacuum seed meter, in other embodiments, other suitable seed/agricultural product meters may be utilized. As used herein, “vacuum” refers to an air pressure that is less than the ambient atmospheric pressure, and not necessarily 0 pa.

In the illustrated embodiment, the row unit 12 also includes a residue management assembly 56 having one or more residue management wheels 58. As illustrated, the residue management assembly 56 is positioned in front of the opener assembly 30 relative to the direction of travel 28, thereby enabling the residue management wheel(s) 58 to break up and/or displace residue and debris (e.g., clods) on the surface 26 of the soil before the opener disc(s) 36 engage the soil 27. In the illustrated embodiment, the residue management wheel(s) 58 are rotatably coupled to an arm 60, and the arm 60 is pivotally coupled to the frame 24 of the row unit 12. In addition, the residue management assembly 56 includes a fluid cylinder 62 extending between the arm 60 and the frame 24 of the row unit 12. The fluid cylinder 62 is configured to control a force applied by the residue management wheel(s) 58 to the soil 27. While the fluid cylinder 62 extends between the frame 24 of the row unit 12 and the arm 60 of the residue management assembly 56 in the illustrated embodiment, in other embodiments, the fluid cylinder may extend to any other suitable portion of the residue management assembly, such as to a hub of the residue management wheel(s). Furthermore, in certain embodiments, the residue management assembly, including the residue management wheel(s), the arm, and the fluid cylinder, may be omitted. In the illustrated embodiment, the fluid cylinders 41, 50 and 62 are closed-circuit fluid cylinders, in which the fluid flows in-between the respective electrical pump and the respective fluid cylinder, through connecting hoses, without going into an external tank (e.g., a tank on the work vehicle) shared with other electrical pumps.

In the illustrated embodiment, the agricultural implement (e.g., planting implement, planter) includes a control system 64 for the fluid cylinders. The control system 64 and the fluid cylinders form a fluid actuation system 66 of the agricultural implement. The control system 64 includes a respective valve assembly 68 fluidly coupled to each of the closing assembly fluid cylinder 41, the packing assembly fluid cylinder 50, and the residue management assembly fluid cylinder 62. The respective valve assembly 68 is configured to control a fluid pressure inside each fluid cylinder (e.g., the fluid cylinder 41, the fluid cylinder 50, the fluid cylinder 62) thereby controlling the force applied by the fluid cylinder to the corresponding ground-engaging tool (e.g., the closing assembly 40, the packer wheel 46, the residue management wheel(s) 58). In the illustrated embodiment in FIG. 2, the control system 64 includes a respective electrical pump 69 dedicated for each fluid cylinder (e.g., the fluid cylinder 41, the fluid cylinder 50, the fluid cylinder 62) and is fluidly coupled to the respective valve assembly 68 and configured to provide pressurized fluid (e.g., air, hydraulic fluid) to the corresponding fluid cylinder. The electrical pumps 69 and the valve assemblies 68 are disposed on the agricultural implement, in certain embodiments, on the row unit 12 (e.g., coupled to the frame of the row unit), and are communicatively coupled to the control system 64 and electrically powered, e.g., by an electrical supply on the work vehicle.

In certain embodiments, the control system 64 includes a controller 70 and a user interface 76. The controller 70 is an electronic controller having electrical circuitry configured to control the valve assemblies 68 and the electric pumps 69. In the illustrated embodiment, the controller 70 includes a processor 72, such as the illustrated microprocessor, and a memory 74. The controller 70 may also include one or more storage devices and/or other suitable components. The processor 72 may be used to execute software, such as software for controlling the valve assemblies and the electric pumps, and so forth. Moreover, the processor 72 may include multiple microprocessors, one or more “general-purpose” microprocessors, one or more special-purpose microprocessors, and/or one or more application specific integrated circuits (ASICs), or some combination thereof. For example, the processor 72 may include one or more reduced instruction set (RISC) processors.

The memory device 74 may include a volatile memory, such as random access memory (RAM), and/or a nonvolatile memory, such as read-only memory (ROM). The memory device 74 may store a variety of information and may be used for various purposes. For example, the memory device 74 may store processor-executable instructions (e.g., firmware or software) for the processor 72 to execute, such as instructions for controlling the valve assemblies 68 and/or the electric pumps 69, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the valve assemblies 68 and/or the electric pumps 69, etc.), and any other suitable data.

Furthermore, in the illustrated embodiment, the control system 64 includes a user interface 76 communicatively coupled to the controller 70. The user interface 76 may include any suitable input devices configured to receive input from an operator, such as button(s), switch(es), knob(s), a keyboard, a mouse, other suitable input device(s), or a combination thereof. In the illustrated embodiment, the user interface 76 includes a display 78 configured to present visual information to the operator. In certain embodiments, the display includes a touch screen interface configured to receive input from the operator. In addition, the user interface may include other suitable device(s) configured to present visual and/or audible information to the operator, such as indicator light(s), gauge(s), speaker(s), other suitable output device(s), or a combination thereof.

The controller 70 is configured to determine a target fluid pressure inside the respective fluid cylinder based on a target force of the respective fluid cylinder and a target damping factor of the respective fluid cylinder. The controller 70 is configured to control each of the valve assemblies such that the fluid pressure inside the respective fluid cylinder is automatically controlled based on the target force and the target damping factor of the respective fluid cylinder. Accordingly, operation of the agricultural implement may be readily adjusted for different soil conditions and/or agricultural implement properties (e.g., speed, position, etc.). For example, an operator may input the target force and/or the target damping factor for a fluid cylinder via the user interface 76. Alternatively, or additionally, the controller may automatically determine the target force and/or the target damping factor based on feedback from sensor(s) (e.g., feedback indicative of one or more properties of the agricultural implement and/or one or more properties of the agricultural field).

For example, a double-acting fluid cylinder(s) may be used in the row unit 12 (e.g., the fluid cylinder 41, the fluid cylinder 50, or the fluid cylinder 62), which includes a base end and a rod end. While a base end pressure (e.g., hydraulic fluid pressure in a hydraulic cylinder, air pressure in an air cylinder) within the base end is greater than a rod end pressure within the rod end, the double-acting fluid cylinder applies a force to the respective ground-engaging tool (e.g., closing disc(s), packer wheel(s), residue management wheel(s), etc.) in a first direction (e.g., downward direction). In addition, while the rod end pressure within the rod end is greater than the base end pressure within the base end, the double-acting fluid cylinder applies a force to the respective ground-engaging tool (e.g., closing disc(s), packer wheel(s), residue management wheel(s), etc.) in a second direction (e.g., upward direction), opposite the first direction. Accordingly, the double-acting fluid cylinder may control the force applied by the respective ground-engaging tool to the soil. The respective valve assembly 68 is configured to control the base end pressure (e.g., hydraulic pressure, air pressure) within the base end of the corresponding double-acting fluid cylinder, and the respective valve assembly 68 is configured to control the rod end pressure (e.g., hydraulic pressure, air pressure) within the rod end of the corresponding double-acting fluid cylinder. Accordingly, the respective valve assembly 68 may control the force applied by the corresponding double-acting fluid cylinder to the respective ground engaging tool. For each double-acting fluid cylinder, the controller 70 is configured to determine a target base end pressure and a target rod end pressure for the respective double-acting fluid cylinder based on a target force and a target damping factor of the respective double-acting fluid cylinder. In addition, the controller 70 is configured to control the valve assemblies 68 and the electric pumps 69 such that a difference between the base end pressure of the respective double-acting fluid cylinder and the target base end pressure is less than a first threshold value and a difference between the rod end pressure of the respective double-acting fluid cylinder and the target rod end pressure is less than a second threshold value. Accordingly, the controller 70 may control each double-acting fluid cylinder to substantially achieve the target force and the target damping (e.g., corresponding to the target damping factor). Because the pressures within the base end and the rod end of the double-acting fluid cylinder are automatically controlled based on the target force and the target damping factor, operation of the agricultural implement may be readily adjusted for different soil conditions and/or agricultural implement properties (e.g., speed, position, etc.).

In certain embodiments, the control system 64 may be configured to control each cylinder of the agricultural implement. However, in other embodiments, the agricultural implement may include multiple control systems, and each control system may be configured to control the cylinders of a respective row unit, a respective group of row units, or a respective type of ground-engaging tool (e.g., closing disc(s), packer wheel(s), residue management wheel(s), etc.) across multiple row units. Furthermore, while double-acting fluid cylinders are used to control the force applied by the closing disc(s), the packer wheel(s), and the residue management wheel(s) to the soil in the illustrated embodiment, in other embodiments, the force applied by at least one of the ground-engaging tools may be controlled by other suitable actuator(s) (e.g., alone or in combination with the double-acting fluid cylinder), such as other suitable actuator(s) (e.g., airbag(s), etc.), hydraulic actuator(s), electromechanical actuator(s), other suitable type(s) of actuator(s), or a combination thereof. For example, single-acting fluid cylinder(s) may be used in the agricultural implement. The controller 70 may be configured to determine a target fluid pressure inside the respective single-acting fluid cylinder based on a target force of the respective single-acting fluid cylinder and a target damping factor of the respective single-acting fluid cylinder. The controller 70 is configured to control each of the valve assemblies such that the fluid pressure inside the respective single-acting fluid cylinder is automatically controlled based on the target force and the target damping factor of the respective single-acting fluid cylinder. Accordingly, operation of the agricultural implement may be readily adjusted for different soil conditions and/or agricultural implement properties (e.g., speed, position, etc.).

In addition, while the fluid actuation system is employed within a planting implement/planter in the illustrated embodiment, in other embodiments, the fluid actuation system (e.g., including the control system and the cylinder(s)) may be utilized within other suitable agricultural implements (e.g., seeding implements/seeders, tillage implements, sprayers, etc.).

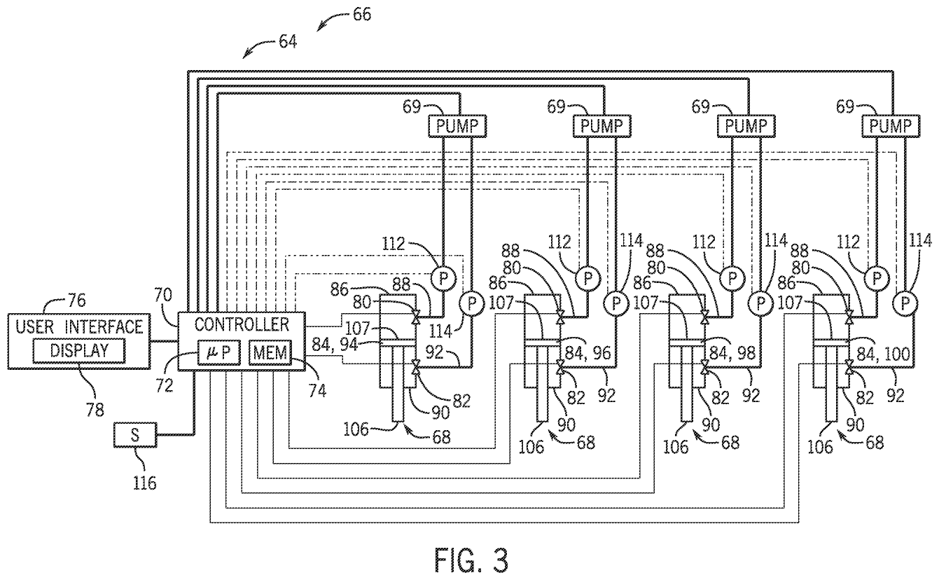

FIG. 3 is a schematic diagram of an embodiment of a fluid actuation system 66 that may be employed within the agricultural implement of FIG. 1. As previously discussed, the fluid actuation system 66 includes the control system 64 and the fluid cylinder(s). In the embodiment illustrated in FIG. 3, closed-circuit double-acting fluid cylinders are used in the fluid actuation system 66, in which the fluid flows in-between the electrical pump and the respective fluid cylinder, through connecting hoses, without going back into an external tank (e.g., a tank on the work vehicle) shared with other electrical pumps. Furthermore, as previously discussed, the control system 64 includes the valve assemblies 68, the electric pumps 69, the controller 70, and the user interface 76. In the illustrated embodiment, each of the valve assemblies 68 includes a base end control valve 80 and a rod end control valve 82 for the corresponding double-acting fluid cylinder. Each base end control valve 80 and each rod end control valve 82 are communicatively coupled to the controller 70, and each base end control valve 80 and each rod end control valve 82 are fluidly coupled to a respective double-acting fluid cylinder 84. As illustrated, each of the base end control valves 80 is fluidly coupled to a base end 86 of the corresponding double-acting fluid cylinders 84 by a corresponding base end conduit 88, and each of the rod end control valves 82 is fluidly coupled to a rod end 90 of the corresponding double-acting fluid cylinders 84 by a corresponding rod end conduit 92.

In the illustrated embodiment, the control system 64 includes four electric pumps 69 fluidly coupled to four valve assemblies 68 and four double-acting fluid cylinders 84, respectively. Each valve assembly 68 is communicatively coupled to the controller 70. Each valve assembly 68 is fluidly coupled to a respective electric pump 69, which is communicatively coupled to the controller 70. The electric pumps 69 may be any type of electrically powered pumps. Each electric pump 69 receives electrical power transferred via electrical line(s), e.g., from the work vehicle, and converts the electrical power to hydraulic power/pneumatic power by moving hydraulic fluid/air through a control valve (e.g., base end control valve 80, rod end control valve 82) and into the corresponding double-acting fluid cylinder 84. Because each of the double-acting fluid cylinders 84 is fluidly coupled to a set of control valves of the respective valve assembly 68 and each control valve is communicatively coupled to the controller 70, the controller may independently control each double-acting fluid cylinder 84. Because each of the electric pumps 69 is communicatively coupled to the controller 70, the controller may independently control each of the electric pumps 69. Each double-acting fluid cylinder 84 may correspond to one of the cylinders disclosed above, such as the closing assembly cylinder, the packing assembly cylinder, or the residue management assembly cylinder, and each double-acting fluid cylinder 84 may be disposed on a different row unit. For example, a first double-acting fluid cylinder 94 may correspond to a residue management assembly cylinder of a first row unit, a second double-acting fluid cylinder 96 may correspond to a residue management assembly cylinder of a second row unit, a third double-acting fluid cylinder 98 may correspond to a residue management assembly cylinder of a third row unit, and a fourth double-acting fluid cylinder 100 may correspond to a residue management assembly cylinder of a fourth row unit. Some of the double-acting fluid cylinders 84 in the fluid actuation system 66 may be hydraulic cylinders (e.g., for down pressure systems), some of the double-acting fluid cylinders 84 in the fluid actuation system 66 may be pneumatic cylinders (e.g., for closing systems and/or residue managers), or a combination thereof.

Accordingly, the fluid actuation system 66 may include one or more hydraulic cylinders, one or more pneumatic cylinders, or any combination thereof.

Furthermore, while each of the electric pumps 69 is fluidly coupled to a single set of control valves and a single double-acting fluid cylinder 84 in the illustrated embodiment, in other embodiments, an electric pump may be fluidly coupled to multiple sets of control valves and multiple double-acting fluid cylinders, respectively. For example, an electric pump may be fluidly coupled to a set of double-acting fluid cylinders and a respective set of control valves. In certain embodiments, the actuation system may include a first set of control valves/double-acting fluid cylinders for the closing disc assemblies, a second set of control valves/double-acting fluid cylinders for the packing assemblies, a third set of control valves/double-acting fluid cylinders for the residue management assemblies, a fourth set of control valves/double-acting fluid cylinders for other suitable ground engaging tool(s), or a combination thereof. The double-acting fluid cylinders within each set of double-acting fluid cylinders may be fluidly coupled in a parallel arrangement and disposed on separate row units to facilitate collective control of the respective ground-engaging tools. Because each of the double-acting fluid cylinders is fluidly coupled to a respective set of control valves, the controller may independently control each of the double-acting fluid cylinders. Because the double-acting fluid cylinders within each set of double-acting fluid cylinders are fluidly coupled to the same electric pump, the electric pump may provide pressurized fluid to each of the cylinders within the set.

In the illustrated embodiment, the base end control valve 80 (e.g., check valve(s), three position valve, etc.) is configured to control fluid/air flow between the base end 86 of the corresponding double-acting fluid cylinder 84 and the fluid supply/atmosphere, and the rod end control valve 82 (e.g., check valve(s), three position valve, etc.) is configured to control fluid/air flow between the rod end 90 of the corresponding double-acting fluid cylinder 84 and the fluid supply/atmosphere. For example, to decrease the pressure within the base end 86 of the double-acting fluid cylinder 84, the base end control valve 80 may vent air within the base end 86 of the double-acting fluid cylinder 84 to the atmosphere. In addition, to decrease the pressure within the rod end 90 of the double-acting fluid cylinder 84, the rod end control valve 82 may vent air within the rod end 90 of the double-acting fluid cylinder 84 to the atmosphere. While a single base end control valve controls airflow into and out of the base end of each double-acting fluid cylinder in the illustrated embodiment, in other embodiments, the valve assembly may include a first base end control valve configured to control airflow into the base end of a double-acting fluid cylinder and a second base end control valve configured to control airflow out of the base end of the double-acting fluid cylinder. In addition, while a single rod end control valve controls airflow into and out of the rod end of each double-acting fluid cylinder in the illustrated embodiment, in other embodiments, the valve assembly may include a first rod end control valve configured to control airflow into the rod end of a double-acting fluid cylinder and a second rod end control valve configured to control airflow out of the rod end of the double-acting fluid cylinder. The above description is equally adapted for use with hydraulic cylinders, in which hydraulic fluid is used instead of air, and the hydraulic fluid is controlled by the valve assemblies to flow into and out of the ends of the cylinders.

The control system 64 is configured to control the force applied by each double-acting fluid cylinder 84 and the damping of each double-acting fluid cylinder 84 by controlling the pressure within the base ends 86 and the rod ends 90 of the double-acting fluid cylinders 84. For example, to drive a piston rod 106 of each double-acting fluid cylinder 84 to extend, the controller 70 may control the corresponding base end control valve 80 and the corresponding rod end control valve 82, such that the base end pressure within the base end 86 of the double-acting fluid cylinder 84 is greater than the rod end pressure within the rod end 90 of the double-acting fluid cylinder 84. In addition, to drive the piston rod 106 of each double-acting fluid cylinder 84 to retract, the controller 70 may control the corresponding base end control valve 80 and the corresponding rod end control valve 82, such that the rod end pressure within the rod end 90 of the double-acting fluid cylinder 84 is greater than the base end pressure within the base end 86 of the double-acting fluid cylinder 84. Furthermore, as discussed in detail below, the controller is configured to control the damping of each double-acting fluid cylinder 84 concurrently with the force adjustment. Because each of the double-acting fluid cylinders 84 is fluidly coupled to the respective set of control valves in the valve assembly 68 via the corresponding base end conduit 88 and the corresponding rod end conduit 90, as disclosed above, movement of one piston rod 106 in response to an external force may not affect fluid pressure in other double-acting fluid cylinders 84. In addition, in the illustrated embodiment, the double-acting fluid cylinders 84 may be controlled independently by the controller 70.

In the illustrated embodiment, each of the double-acting fluid cylinders 84 is fluidly coupled to a first pressure sensor 112 and a second pressure sensor 114. As illustrated, the first and second pressure sensors are communicatively coupled to the controller 70. The first pressure sensor 112 is configured to output a first sensor signal indicative of the base end pressure within the base end 86 of the corresponding double-acting fluid cylinder 84, and the second pressure sensor 114 is configured to output a second sensor signal indicative of the rod end pressure within the rod end 90 of the corresponding double-acting fluid cylinder 84. As discussed in detail below, the controller may utilize the feedback from the respective pressure sensors to control the base end pressure within the base end 86 of each double-acting fluid cylinder 84 and the rod end pressure within the rod end 90 of the double-acting fluid cylinder 84.

The controller 70 is configured to determine a target base end pressure within the base end 86 and a target rod end pressure within the rod end 90 of each double-acting cylinder 84 based on a target force of the double-acting cylinder 84 and a target damping factor of the double-acting cylinder. The target force of the double-acting cylinder 84 may be determined based on a target force of the ground-engaging tool coupled to the double-acting cylinder (e.g., the target force applied by the ground-engaging tool to the soil). For example, if the target force of the ground-engaging tool is greater than the weight of the ground-engaging tool and any arm(s) that couple the ground-engaging tool to the frame of the row unit, the target force of the double-acting cylinder may be in a downward direction (e.g., downforce). However, if the target force of the ground-engaging tool is less than the weight of the ground-engaging tool and any arm(s) that couple the ground-engaging tool to the frame of the row unit, the target force of the double-acting cylinder may be an upward direction (e.g., up-force). Furthermore, the target damping factor represents a value (e.g., between 0 and 1) of a target resistance to movement of the double-acting cylinder. For example, a target damping factor of 0 may correspond to minimum damping of the double-acting cylinder (e.g., about the least damping the actuation system is capable of establishing within the double-acting cylinder for a force applied by the double-acting cylinder), and a target damping factor of 1 may correspond to a maximum damping of the double-acting cylinder (e.g., about the most damping the actuation system is capable of establishing within the double-acting cylinder for a force applied by the double-acting cylinder). While a damping factor between 0 and 1 is disclosed herein, any suitable numerical representation of the damping factor may be utilized in certain embodiments.

In certain embodiments, the user interface 76 is configured to output a signal indicative of the target force of each double-acting fluid cylinder and/or the target damping factor of each double-acting fluid cylinder, and the controller 70 is configured to receive the signal from the user interface. For example, the user interface 76 may enable an operator to select from a set of target damping factors. Furthermore, the signal indicative of the target force from the user interface may be indicative of a target contact force between the ground-engaging tool and the soil, and the controller may determine the target force of the double-acting fluid cylinder based on the target contact force between the ground-engaging tool and the soil (e.g., based on the weight of the ground-engaging tool and any arm(s) that couple the ground-engaging tool to the frame of the row unit). Additionally or alternatively, the controller may receive signal(s) indicative of the target force of the double-acting fluid cylinder and/or the target damping factor of the double-acting fluid cylinder from another suitable device/system (e.g., a remote control system, etc.).

Furthermore, in certain embodiments, the controller 70 may determine the target force of each double-acting fluid cylinder and/or the target damping factor of each double-acting fluid cylinder based on feedback from one or more sensors 116 (e.g., soil sensor(s), residue monitoring sensor(s), position sensor(s), speed sensor(s), etc.) communicatively coupled to the controller 70. For example, the sensor may output a sensor signal indicative of one or more properties of the agricultural implement (e.g., position, speed, etc.) and/or one or more properties of the agricultural field in which the agricultural implement is located (e.g., soil density, soil moisture, soil composition, terrain roughness, residue density, etc.). In certain embodiments, the controller 70 may increase the target damping factor in response to sensor feedback indicative of rougher terrain, and the controller may decrease the target damping factor in response to smoother terrain. Additionally or alternatively, the controller may increase the target damping factor in response to sensor feedback indicative of a higher implement speed, and the controller may decrease the target damping factor in response to sensor feedback indicative of a lower implement speed. Additionally or alternatively, with regard to controlling the residue management wheel(s), the controller may determine the target force based on sensor feedback indicative of residue density. Additionally or alternatively, with regard to controlling the packer wheel, the controller may determine the target force based on sensor feedback indicative of soil hardness. Furthermore, in certain embodiments, the controller may determine the target force and/or the target damping factor based on sensor feedback indicative of a position of the implement/row unit within a field (e.g., by using one or more maps of the field, such as a soil density map, a residue density map, a terrain map, a soil moisture map, other suitable map(s), or a combination thereof).

In certain embodiments, while the target damping factor is zero (e.g., minimum damping), the controller 70 may determine the target base end pressure and the target rod end pressure by setting one of the target base end pressure or the target rod end pressure to a lower pressure limit. For example, while the target damping factor is zero and the target force is in the direction of extension of the double-acting fluid cylinder, the controller 70 may set the target rod end pressure to the lower pressure limit. The controller 70 may then determine the target base end pressure based on the target rod end pressure or the rod end pressure (e.g., as measured by the second pressure sensor 114) and the target force (e.g., by multiplying the target rod end pressure/rod end pressure by an area of the rod side of the piston 107, adding the target force, and dividing by an area of the base side of the piston 107). In addition, while the target damping factor is zero and the target force is in the direction of retraction of the double-acting fluid cylinder, the controller 70 may set the target base end pressure to the lower pressure limit. The controller 70 may then determine the target rod end pressure based on the target base end pressure or the base end pressure (e.g., as measured by the first pressure sensor 112) and the target force (e.g., by multiplying the target base end pressure/base end pressure by the area of the base side of the piston 107, adding the target force, and dividing by the area of the rod side of the piston 107). Furthermore, in certain embodiments, while the target damping factor is zero (e.g., minimum damping), the controller 70 may determine the target base end pressure and the target rod end pressure by minimizing a sum of the target base end pressure and the target rod end pressure.

In certain embodiments, while the target damping factor is one (e.g., maximum damping), the controller 70 may determine the target base end pressure and the target rod end pressure by setting one of the target base end pressure or the target rod end pressure to an upper pressure limit. For example, while the target damping factor is one and the target force is in the direction of extension of the double-acting fluid cylinder, the controller 70 may set the target base end pressure to the upper pressure limit. The controller 70 may then determine the target rod end pressure based on the target base end pressure or the base end pressure (e.g., as measured by the first pressure sensor 112) and the target force (e.g., by multiplying the target base end pressure/base end pressure by the area of the base side of the piston 107, subtracting the target force, and dividing by the area of the rod side of the piston 107). In addition, while the target damping factor is one and the target force is in the direction of retraction of the double-acting fluid cylinder, the controller 70 may set the target rod end pressure to the upper pressure limit. The controller 70 may then determine the target base end pressure based on the target rod end pressure or the rod end pressure (e.g., as measured by the second pressure sensor 114) and the target force (e.g., by multiplying the target rod end pressure/rod end pressure by the area of the rod side of the piston 107, subtracting the target force, and dividing by an area of the base side of the piston 107). Furthermore, in certain embodiments, while the target damping factor is one (e.g., maximum damping), the controller 70 may determine the target base end pressure and the target rod end pressure by maximizing a sum of the target base end pressure and the target rod end pressure.

Furthermore, any suitable relationship may be used to determine the target base end pressure and the target rod end pressure based on the target force and the target damping factor. For example, the controller 70 may utilize the following formulas to determine the target base end pressure and the target rod end pressure while the target force is in the direction of extension:

$${P}_{B} = ( 1 - D ) ( \frac{F}{{A}_{B}} + {P}_{LL} \frac{{A}_{R}}{{A}_{B}} ) + {DP}_{UL}$$

$${P}_{R} = \frac{{P}_{B} {A}_{B} - F}{{A}_{R}}$$

P_{B} is the target base end pressure, P_{R} is the target rod end pressure, D is the target damping factor, F is the target force, A_{B} is an area of the base side of the piston of the double-acting fluid cylinder, P_{LL} is a lower pressure limit, A_{R} is an area of the rod side of the piston of the double-acting fluid cylinder, and P_{UL} is an upper pressure limit. While the target base end pressure is used to determine the target rod end pressure, in certain embodiments, the base end pressure (e.g., as measured by the first sensor) may be used to determine the target rod end pressure. Furthermore, the controller 70 may utilize the following formulas to determine the target base end pressure and the target rod end pressure while the target force is in the direction of retraction of the double-acting fluid cylinder:

$${P}_{R} = ( 1 - D ) ( \frac{F}{{A}_{R}} + {P}_{LL} \frac{{A}_{B}}{{A}_{R}} ) + {DP}_{UL}$$

$${P}_{B} = \frac{{P}_{R} {A}_{R} - F}{{A}_{B}}$$

While the target rod end pressure is used to determine the target base end pressure, in certain embodiments, the rod end pressure (e.g., as measured by the second sensor) may be used to determine the target base end pressure. While the controller may use the equations listed above to determine the target rod end pressure and the target base end pressure in certain embodiments, in other embodiments, the controller may use other suitable equations to determine the target rod end pressure and the target base end pressure based on the target force and the target damping. Furthermore, in certain embodiments, the controller may use another suitable type of relationship to determine the target rod end pressure and the target base end pressure based on the target force and the target damping, such as look-up table(s).

Any suitable values may be selected for the lower pressure limit and the upper pressure limit, in which the upper pressure limit is greater than the lower pressure limit. For example, in certain embodiments, the lower pressure limit may be set to atmospheric pressure (e.g., measured atmospheric pressure, determined atmospheric pressure, standard atmospheric pressure, etc.) or the pressure within the hydraulic supply, and the upper pressure limit may be associated with a maximum pressure (e.g., provided by manufacturers) associated with the corresponding electric pump 69. Additionally or alternatively, in certain embodiments, the lower pressure limit may be set to a value greater than the atmospheric pressure (e.g., measured atmospheric pressure, determined atmospheric pressure, standard atmospheric pressure, etc.). Setting the lower pressure limit to a value greater than the atmospheric pressure may reduce the time associated with decreasing pressure within an end of the double-acting fluid cylinder (e.g., to the lower pressure limit) due to the increased pressure differential between the pressure within the end and the atmospheric pressure. Additionally or alternatively, in certain embodiments, the upper pressure limit may be set to a value lower than the maximum pressure associated with the corresponding electric pump 69. Setting the upper pressure limit to a value lower than the maximum pressure associated with the corresponding electric pump 69 may protect the electric pump and extend the lifetime of the electric pump.

Once the controller determines the target base end pressure within the base end 86 and the target rod end pressure within the rod end 90 of the double-acting fluid cylinder 84 based on the target force of the double-acting fluid cylinder 84 and the target damping factor of the double-acting fluid cylinder, the controller may control the valve assembly 68 such that a difference between the base end pressure (e.g., as measured by the first pressure sensor 112) and the target base end pressure is less than a first threshold value and a difference between the rod end pressure (e.g., as measured by the second pressure sensor 114) and the target rod end pressure is less than a second threshold value. For example, the controller 70 may control the base end control valve 80 such that the difference between the base end pressure and the target base end pressure is less than the first threshold value, and the controller 70 may control the rod end control valve 80 such that the difference between the rod end pressure and the target rod end pressure is less than the second threshold value.

In the illustrated embodiment, the controller 70 may utilize feedback from the pressure sensors to determine the base end pressure and the rod end pressure. For example, the controller may determine the base end pressure within the base end 86 of the double-acting fluid cylinder 84 based on feedback from the first pressure sensor 112, and the controller may determine the rod end pressure within the rod end 90 of the double-acting fluid cylinder 84 based on feedback from the second pressure sensor 114. However, in certain embodiments, the pressure sensors may be omitted, and the controller may adjust the base end pressure and the rod end pressure via open loop control of the valve assembly 68. Each threshold value may be any suitable pressure difference (e.g., represented as a pressure or a percentage). For example, at least one threshold value may be a pressure difference of less than 10 percent, less than 5 percent, less than 2 percent, less than 1 percent, or less than 0.5 percent. Furthermore, the first and second threshold values may be the same as one another or different than one another.

While control of a single double-acting fluid cylinder is disclosed above for simplicity/clarity, the control system may control each double-acting fluid cylinder in the illustrated embodiment in FIG. 3. Furthermore, the process of controlling the pressure within the double-acting fluid cylinders disclosed above may apply to each set of control valves/double-acting fluid cylinders. In addition, while double-acting fluid cylinders are disclosed herein, the process of controlling pressure may be applied to opposing cylinders (e.g., in which the pistons are coupled to one another, and the pressure within the base ends is controlled) or to opposing air bags (e.g., in which the pressure within each air bag is controlled), or to single-acting cylinders.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A control system for an agricultural implement, comprising:
a first electric pump fluidly coupled to a first fluid cylinder, wherein the first electric pump is disposed on the agricultural implement, and the first fluid cylinder is configured to apply a force to a first ground-engaging tool of the agricultural implement;
a second electric pump fluidly coupled to a second fluid cylinder, wherein the second electric pump is disposed on the agricultural implement, and the second fluid cylinder is configured to apply a force to a second ground-engaging tool of the agricultural implement; and
a controller communicatively coupled to the electric pump, wherein the controller comprises a memory and a processor, and the controller is configured to:
determine a first target fluid pressure inside the first fluid cylinder based on a first target force of the first fluid cylinder;
determine a second target fluid pressure inside the second fluid cylinder based on a second target force of the second fluid cylinder;
control the first electric pump to adjust a first fluid pressure inside the first fluid cylinder such that a first difference between the first fluid pressure and the first target fluid pressure is less than a first threshold; and
control the second electric pump to adjust a second fluid pressure inside the second fluid cylinder such that a second difference between the second fluid pressure and the second target fluid pressure is less than a second threshold.

2. The control system of claim 1, wherein at least one electric pump of the first electric pump and the second electric pump is configured to have an amount of fluid flowing in-between the at least one electric pump and corresponding fluid cylinder coupled to the at least one electric pump without connecting to an external fluid supply.

3. The control system of claim 2, wherein the external fluid supply is disposed on a work vehicle.

4. The control system of claim 1, wherein a fluid supply for at least one of the first electric pump and the second electric pump is disposed on the agricultural implement.

5. The control system of claim 1, wherein the first electric pump and the second electric pump are hydraulic, or pneumatic, or a combination thereof.

6. The control system of claim 1, comprises a first valve assembly and a second valve assembly, wherein the first electric pump is fluidly coupled to the first fluid cylinder via the first valve assembly and the second electric pump is fluidly coupled to the second fluid cylinder via the second valve assembly.

7. The control system of claim 6, wherein at least one of the first valve assembly and the second valve assembly is disposed on the agricultural implement.

8. The control system of claim 6, wherein the controller is configured to:
control the first valve assembly to adjust the first fluid pressure inside the first fluid cylinder; and
control the second valve assembly to adjust the second fluid pressure inside the first fluid cylinder.

9. The control system of claim 1, comprising a sensor communicatively coupled to the controller and configured to output a signal indicative of at least one property of the agricultural implement, at least one property of an agricultural field in which the agricultural implement is located, or a combination thereof, wherein the controller is configured to determine the first target force and the second target force based on the at least one property of the agricultural implement, the at least one property of the agricultural field, or the combination thereof.

10. A control system for an agricultural implement, comprising:
a plurality of electric pumps fluidly coupled to a plurality of fluid cylinders via a plurality of valve assemblies, wherein the plurality of electric pumps and the plurality of valve assemblies are disposed on the agricultural implement, and each fluid cylinder of the plurality of fluid cylinders is configured to apply a force to a respective ground-engaging tool of the agricultural implement; and
a controller communicatively coupled to the plurality of electric pumps and the plurality of valve assemblies, wherein the controller comprises a memory and a processor, and the controller is configured to:
determine a respective target fluid pressure for each fluid cylinder of the plurality of fluid cylinders based on a respective target force of the fluid cylinder; and
control the plurality of electric pumps, the plurality of valve assemblies, or a combination thereof, such that a respective difference between the respective target fluid pressure and a respective fluid pressure in each fluid cylinder is less than a respective threshold value.

11. The control system of claim 10, wherein the plurality of fluid cylinders are hydraulic, or pneumatic, or a combination thereof.

12. The control system of claim 10, wherein at least one electric pump of the plurality of electric pump is configured to have an amount of fluid flowing in-between the at least one electric pump and respective fluid cylinders coupled to the at least one electric pump without connecting to an external fluid supply.

13. The control system of claim 10, wherein a fluid supply for at least one electric pump of the plurality of electric pumps is disposed on the agricultural implement.

14. The control system of claim 10, wherein each electric pump of the plurality of electric pumps is individually coupled to a respective fluid cylinder of the plurality of fluid cylinders via a respective valve assembly of the plurality of valve assemblies.

15. The control system of claim 10, comprising a sensor communicatively coupled to the controller and configured to output a signal indicative of at least one property of the agricultural implement, at least one property of an agricultural field in which the agricultural implement is located, or a combination thereof, wherein the controller is configured to determine the respective target force based on the at least one property of the agricultural implement, the at least one property of the agricultural field, or the combination thereof.

16. A method for manufacturing an agricultural implement, comprising:
selecting a number of electric pumps based on a number of fluid cylinders on the agricultural implement;
disposing the electric pumps on the agricultural implement;
fluidly coupling each electric pump of the electric pumps to one or more fluid cylinders of the fluid cylinders on the agricultural implement; and
communicatively coupling a controller to the electric pumps, wherein the controller is configured to:
determine a respective target fluid pressure for each fluid cylinder of the fluid cylinders based on a respective target force of respective fluid cylinder to apply to a respective ground-engaging tool of the agricultural implement; and
control each of the electric pumps independently such that a respective difference between the respective target fluid pressure and a respective fluid pressure in each fluid cylinder of the fluid cylinder is less than a respective threshold value.

17. The method of claim 16, comprising:
disposing a fluid supply for at least one fluid cylinder of the fluid cylinders on the agricultural implement.

18. The method of claim 16, wherein selecting the number of the electric pumps comprises selecting at least one electric pump for each fluid cylinder of the fluid cylinders on the agricultural implement.

19. The method of claim 18, wherein the electric pumps are hydraulic, or pneumatic, or a combination thereof.

20. The method of claim 16, selecting the number of the electric pumps comprises selecting a particular electric pump, in which fluid flows in-between the particular electric pump and respective one or more fluid cylinders coupled to the particular electric pump without connecting to an external fluid supply.
